(19) United States
(12) Patent Application Publication
(10) Pub. No.: US 2024/0012315 A1
(43) Pub. Date: Jan. 11, 2024

(54) MOUNT AND CAMERA SYSTEM

(71) Applicant: SZ DJI TECHNOLOGY CO., LTD., Shenzhen (CN)

(72) Inventor: Futoshi IINUMA, Shenzhen (CN)

(73) Assignee: SZ DJI TECHNOLOGY CO., LTD., Shenzhen (CN)

(21) Appl. No.: 18/372,751

(22) Filed: Sep. 26, 2023

Related U.S. Application Data
(63) Continuation of application No. PCT/CN2022/084811, filed on Apr. 1, 2022.

(30) Foreign Application Priority Data
Apr. 2, 2021 (JP) 2021-063532

(51) Int. Cl. G03B 17/14; G03B 17/56

(52) U.S. Cl. CPC G03B 17/14; G03B 17/561

(57) ABSTRACT

A mount of a photographing device may include a mount module and a restriction structure. The mount module may include an opening to embed a portion of a mount structure of an interchangeable lens, a first engagement portion protruding inwardly into the opening, and a first mount face opposite to a second mount face of the interchangeable lens. When the interchangeable lens rotates from a first rotational position to a second rotational position in a first rotational direction, the first engagement portion may engage with a second engagement portion protruding from an outer peripheral surface of the mount structure of the interchangeable lens. The restriction structure may restrict further rotation of the interchangeable lens from the second rotational position in the first rotational direction to a third rotational position.

### CROSS-REFERENCE TO RELATED APPLICATIONS

The present application is a continuation of International Application No. PCT/CN2022/084811, filed Apr. 1, 2022, which claims priority to JP 2021-063532, filed Apr. 2, 2021, the entire contents of each being incorporated herein by reference in its entirety.

### TECHNICAL FIELD

The present application relates to a mount and a camera system.

### BACKGROUND

A support mechanism for rotatably supporting a photographing device which detachably holds a lens unit is disclosed in Patent Document 1.
[Patent Document 1] Japan Patent Publication No. 2019-203938.

### SUMMARY

### Technical Problem to be Solved by the Disclosure

Depending on the shape of the lens unit, the lens unit and the support mechanism may interfere with each other when the lens unit is mounted on the camera unit supported by the support mechanism.

### Technical Features for Solving the Problems

A mount for removably retaining an interchangeable lens covered by an aspect of the present disclosure may comprise: an opening embedding a portion of a mount structure of the interchangeable lens; and a first engagement portion protruding inwardly of the opening. The first engagement portion may be engaged with a second engagement portion protruding from an outer periphery of the mount structure of the interchangeable lens by rotating the interchangeable lens from a first rotational position to a second rotational position along a first rotational direction, and the first engagement portion may be disengaged from the second engagement portion by rotating the interchangeable lens from the second rotational position to the first rotational position along a second rotational direction opposite to the first rotational direction. The mount may include a mount module that includes a first mount surface opposite a second mount surface of the interchangeable lens. The mount may include a restriction mechanism that restricts further rotation of the interchangeable lens from the second rotational position to the third rotational position in the first rotational direction.

One aspect of the present disclosure is a mount of a photographing device. The mount may comprise a mount module to mount an interchangeable lens and a restriction structure. The mount module may comprise an opening to embed a portion of a mount structure of the interchangeable lens, a first engagement portion protruding inwardly into the opening, and a first mount face opposite to a second mount face of the interchangeable lens. When the interchangeable lens rotates from a first rotational position to a second rotational position in a first rotational direction, the first engagement portion may engage with a second engagement portion protruding from an outer peripheral surface of the mount structure of the interchangeable lens. When the interchangeable lens rotates from the second rotational position to the first rotational position in a second rotational direction opposite to the first rotational direction, the first engagement portion may be disengaged from the second engagement portion. The restriction structure may restrict further rotation of the interchangeable lens from the second rotational position in the first rotational direction to a third rotational position.

It should be understood that the above general description and the following detailed description are only exemplary and explanatory and are not restrictive of the present disclosure.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 is a three-dimensional view of an exterior of a photographing device according to one embodiment of the present disclosure.

FIG. 2 is a three-dimensional view of an exterior of a photographing device according to one embodiment of the present disclosure.

FIG. 3 is a three-dimensional view of an exterior of a camera system including a photographing device and a gimbal according to one embodiment of the present disclosure.

FIG. 4 is a diagram illustrating an interchangeable lens without a protruding portion mounted on a photographing device according to one embodiment of the present disclosure.

FIG. 5 is a three-dimensional view illustrating appearance of an interchangeable lens having a protruding portion according to one embodiment of the present disclosure.

FIG. 6 is a diagram illustrating a situation in which an interchangeable lens having a protruding portion is mounted on a photographing device according to one embodiment of the present disclosure.

FIG. 7 is a top view of a back side of the mount module according to one embodiment of the present disclosure.

FIG. 8A is a three-dimensional view of appearance of a mount module as viewed from the back side of the mount module according to one embodiment of the present disclosure.

FIG. 8B is a partially enlarged view of the mount module according to one embodiment of the present disclosure.

FIG. 9A is a diagram illustrating an interchangeable lens mounted on a mount module according to one embodiment of the present disclosure.

FIG. 9B is an enlarged three-dimensional view of the restriction mechanism shown in FIG. 9A according to one embodiment of the present disclosure.

FIG. 10A is a diagram illustrating an interchangeable lens mounted on a mount module according to one embodiment of the present disclosure.

FIG. 10B is an enlarged three-dimensional view of the restraining mechanism shown in FIG. 10A.

FIG. 11A is a diagram illustrating an interchangeable lens mounted on a mount module according to one embodiment of the present disclosure.

FIG. 11B is an enlarged three-dimensional view of the restriction mechanism shown in FIG. 11A according to one embodiment of the present disclosure.

FIG. 12A is a diagram illustrating an interchangeable lens mounted on a mount module according to one embodiment of the present disclosure.

FIG. 12B is an enlarged three-dimensional view of the restriction mechanism shown in FIG. 12A according to one embodiment of the present disclosure.

FIG. 13 is a diagram illustrating appearance of an unmanned aerial vehicle and a remotely operated device according to one embodiment of the present disclosure.

### DETAILED DESCRIPTION

Below, the disclosure is illustrated by means of embodiments of the disclosure, but the following embodiments are not intended to limit the disclosure covered by the claims. Furthermore, not all combinations of features illustrated in the embodiments are necessary for the solution of the disclosure.

The claims, the specification, the drawings accompanying the specification, and the abstract of the specification contain matters protected by copyright. The copyright holder will not object to any person making copies of these documents as indicated in the documents or records of the Patent Office. However, all copyrights are reserved except in such cases.

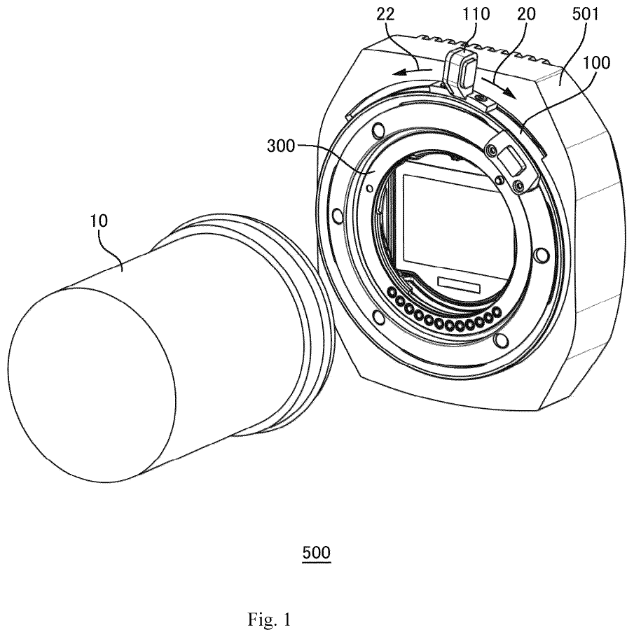

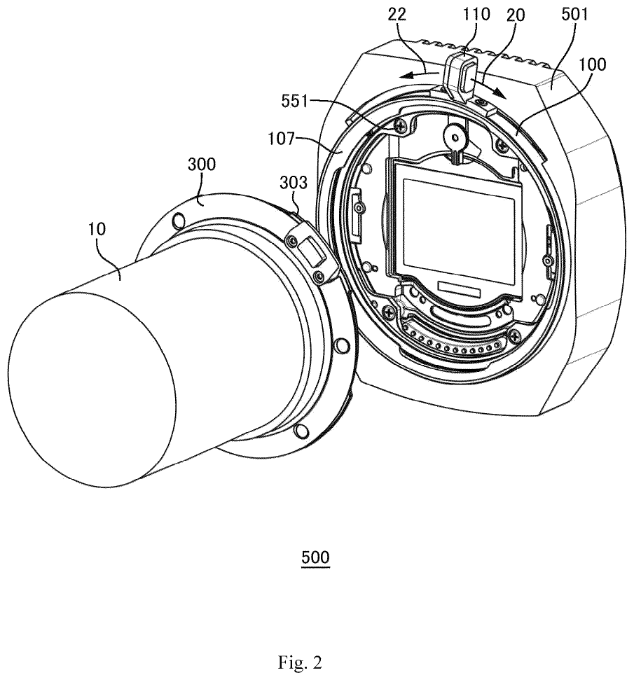

FIGS. 1 and 2 are three-dimensional views illustrating appearance of a photographing device 500 according to one embodiment of the present disclosure. The photographing device 500 includes an intermediate mount 100, a mount module 300, an interchangeable lens 10, and a housing 501. The intermediate mount 100, the mount module 300, and the interchangeable lens are detachably disposed on the housing 501. The interchangeable lens 10 is an example of a lens unit. The photographing device 500 includes an image sensor comprising a CCD or CMOS. The image sensor captures an image formed through the interchangeable lens 10.

In one embodiment, as shown in FIG. 1, the interchangeable lens 10 is detachably held on the mount module 300. The mount module 300 may hold the interchangeable lens 10 by means of a so-called mount-type disassembly mechanism or structure. In addition, as shown in FIG. 2, the mount module 300 is detachably held on the photographing device 500 by means of an intermediate mount 100. The intermediate mount 100 may be detachably secured to the photographing device 500. The intermediate mount 100 may be detachably secured to the photographing device 500 by screws 551.

In one embodiment, the intermediate mount 100 can hold the mount module 300 by means of a mount-type disassembly mechanism. The intermediate mount 100 includes an operating member 110. The intermediate mount 100 is an annular or ring shape. The intermediate mount 100 includes an opening and an engagement portion 107 that is a claw portion protruding inwardly from an inner periphery of the opening. The mount module 300 is an annular or ring shape. The mount module 300 includes an engagement portion 303 that is a claw portion protruding from an outer peripheral surface. By operating the operating member 110, the intermediate mount 100 may rotate in a clockwise direction of rotation 20 or a counterclockwise direction of rotation 22. In a state in which the mount module 300 is configured within the opening of the intermediate mount 100, when the intermediate mount 100 is rotated in the rotational direction 20, the engagement portion 107 of the intermediate mount 100 snaps together with the engagement portion 303 of the mount module 300, and the intermediate mount 100 retains the mount module 300.

In one embodiment, the mount module 300 is a mount corresponding to a mount specification of the interchangeable lens 10. The mount module 300, which may be one of a plurality of different mount specifications, is the mount corresponding to the mount specification of the interchangeable lens 10 retained in the mount module 300. The mount module 300 may be replaced according to the mount specification of the interchangeable lens 10 mounted on the photographing device 500.

The mount module 300 is an example of a mount that detachably holds an interchangeable lens. Also, in this embodiment, the manner in which the mount module 300 is detachably provided on the photographing device 500 through the intermediate mount 100 is described. However, the mount module 300 may also be directly secured to the photographing device 500 without using the intermediate mount 100 by utilizing screws or the like.

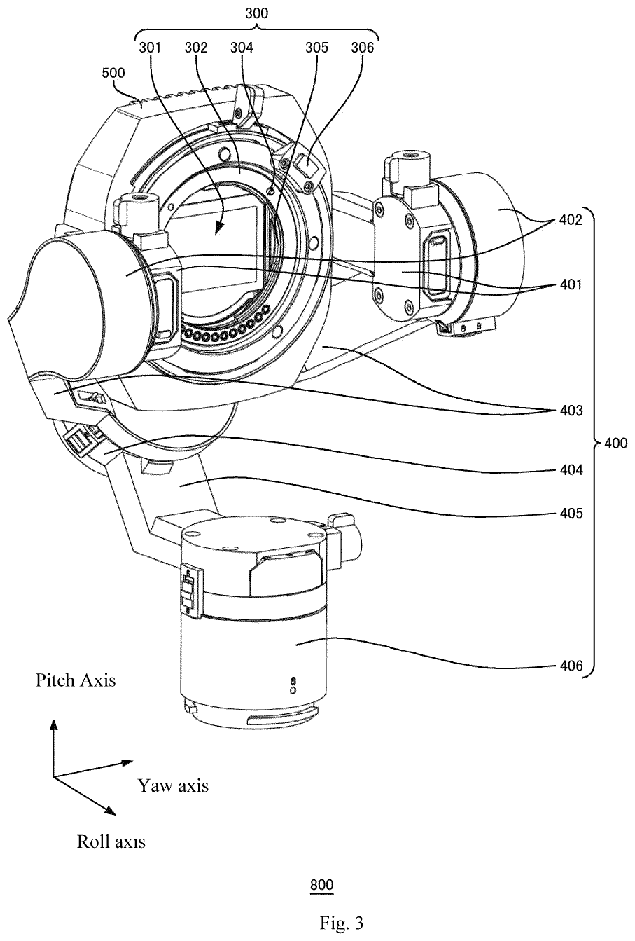

FIG. 3 illustrates a three-dimensional view of appearance of a camera system 800 including a photographing device 500 and a gimbal 400 according to one embodiment of the present disclosure. The gimbal 400 is an example of a support mechanism.

In one embodiment, the gimbal 400 rotatably supports the photographing device 500. The gimbal 400 rotatably supports the photographing device 500 around a pitch axis, a yaw axis, and a roll axis. The gimbal 400 comprises a pair of a first retaining member 401, a first rotating mechanism 402, a second retaining member 403, a second rotating mechanism 404, a third retaining member 405, and a third rotating mechanism 406. The pair of the first retaining members 401 holds the photographing device 500. The pair of the first retaining members 401 is secured at each end to two sides of the photographing device 500. The first retaining members 401 retain the photographing device 500. One end of each of the pair of the first retaining members 401 is secured to one side of the photographing device 500, respectively. The other end of each of the pair of first retaining members 401 is integrally provided with one of a pair of first rotating mechanisms 402. The pair of first rotating mechanisms 402 rotates the photographing device 500 through the pair of the first retaining members 401 around a pitch axis. The pair of first rotating mechanisms 402 are provided with a first built-in motor that rotates the pair of first retaining members 401.

In one embodiment, a second retaining member 403 extends two arms from the central portion, holding the pair of first rotating mechanisms 402 at respective ends of the two arms. The second retaining member 403 is rotatably coupled to the second rotating mechanism 404 at the central portion relative to the second rotating mechanism 404. The second rotating mechanism 404 rotates the photographing device 500 around the roll axis through the second retaining member 403. The second rotating mechanism 404 has a second built-in motor that rotates the second retaining member 403.

In one embodiment, the third retaining member 405 holds the second rotating mechanism 404. The second rotating mechanism 404 is integrally provided at one end of the third retaining member 405. The third rotating mechanism 406 is integrally provided at the other end of the third retaining member 405. The third rotating mechanism 406 rotates the photographing device 500 around the yaw axis through the third retaining member 405. The third rotating mechanism 406 is provided with a third built-in motor that rotates the third retaining member 405.

In one embodiment, the mount module 300 includes an opening 301, a mount face 302, a pin 304, and an engagement portion 305. A portion of the mount of the interchangeable lens is embedded in the opening 301. A front portion of the mount of the interchangeable lens is embedded in the opening 301.

In one embodiment, the engagement portion 305 is a claw portion provided along the edge of the opening 301 and protruding toward the inner side of the opening 301. By rotating the interchangeable lens from the first rotational position to the second rotational position along the rotational direction 22, the engagement portion 305 snaps together with the engagement portion (claw portion) protruding from the outer periphery of the mount structure of the interchangeable lens. In addition, by rotating the interchangeable lens from the second rotational position to the first rotational position along the rotational direction 20, the engagement portion 305 is disengaged from the engagement portion of the interchangeable lens. The mount surface 302 is annular in shape and is opposite to the mount surface of the interchangeable lens. The mount module 300 includes a plurality of electrical contacts on the mount surface 302, which are electrically connected to a plurality of electrical contacts provided on the mount surface of the interchangeable lens.

In one embodiment, the first rotational position indicates the position of the interchangeable lens with respect to the mount module 300 when the mount of the interchangeable lens is embedded in the opening 301 and the interchangeable lens is mounted to the mount module 300. The second rotational position indicates the position of the interchangeable lens with respect to the mount module 300 when the pin 304 is embedded in the hole in the mount face of the interchangeable lens and the installation of the interchangeable lens into the mount module 300 is completed. The second rotational position indicates the position of the interchangeable lens with respect to the mount module 300 in a state in which the plurality of electrical contacts of the interchangeable lens are electrically connected to the plurality of electrical contacts of the mount module 300 respectively.

In one embodiment, the mount module 300 includes a pin 304 on the mount face 302 that is embedded in a hole provided in the mount face of the interchangeable lens when the interchangeable lens is in the second rotational position. The pin 304 is pressed by an elastic component such as a spring with a force in a direction of protrusion from the mount face 302. When the interchangeable lens is mounted toward the mount module 300, the pin 304 is pressed on the mount face of the interchangeable lens and is pressed into the interior of the mount face 302. Then, when the interchangeable lens is rotated and the interchangeable lens reaches the second rotational position, the pin 304 is pressed by the elastic component to protrude from the mount face 302 and is embedded in the hole provided in the mount face of the interchangeable lens. As a result, the interchangeable lens is mounted to the mount module 300 and cannot rotate relative to the mount module 300.

In one embodiment, the mount module 300 further includes a button 306 mechanically coupled to the pin 304 at an outer periphery of the mount face 302 to press the pin 304 into the interior of the mount face 302. By pressing the button 306, the pin 304 is pressed into the interior of the mount face 302 to enable the interchangeable lens to rotate relative to the mount module 300. In the state of pressing the button 306, the interchangeable lens may be rotated from the second rotational position to the first rotational position along the rotational direction 20 in a direction opposite to the direction in which it was installed, so that the engagement of the engagement portion 305 to the engagement portion of the interchangeable lens is released and the interchangeable lens becomes removable from the mount module 300.

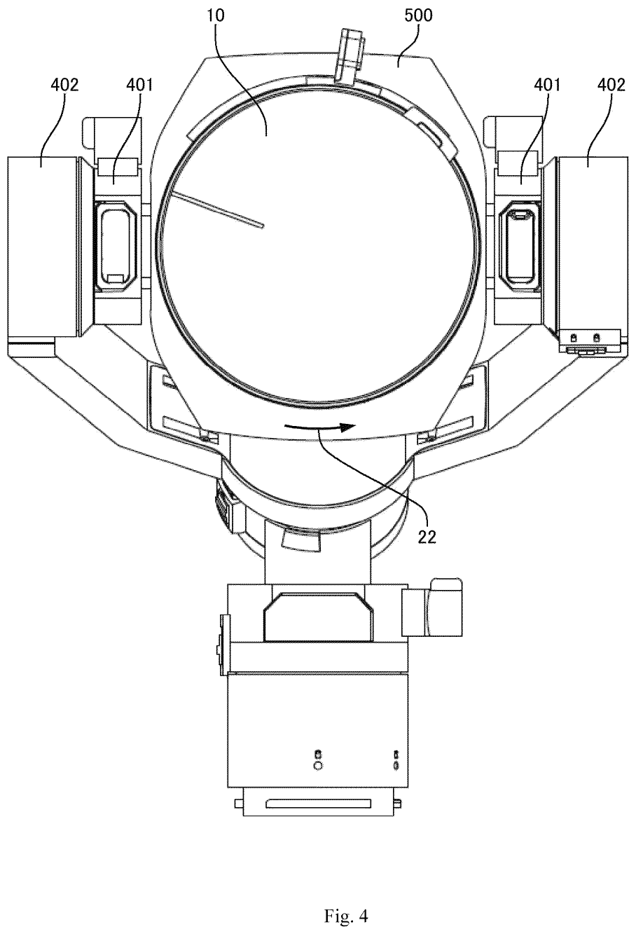

FIG. 4 is a diagram illustrating a situation in which the interchangeable lens 10 is mounted on the photographing device 500 according to one embodiment of the present application. If the interchangeable lens 10 does not have a protruding portion that protrudes relatively large from the outer periphery, it does not interfere with the first retaining member 401 of the gimbal 400, and, for example, it is possible to mount the interchangeable lens 10 on the mount module 300 by rotating the interchangeable lens by 70 degrees in the state in which the interchangeable lens 10 is embedded in the mount module 300.

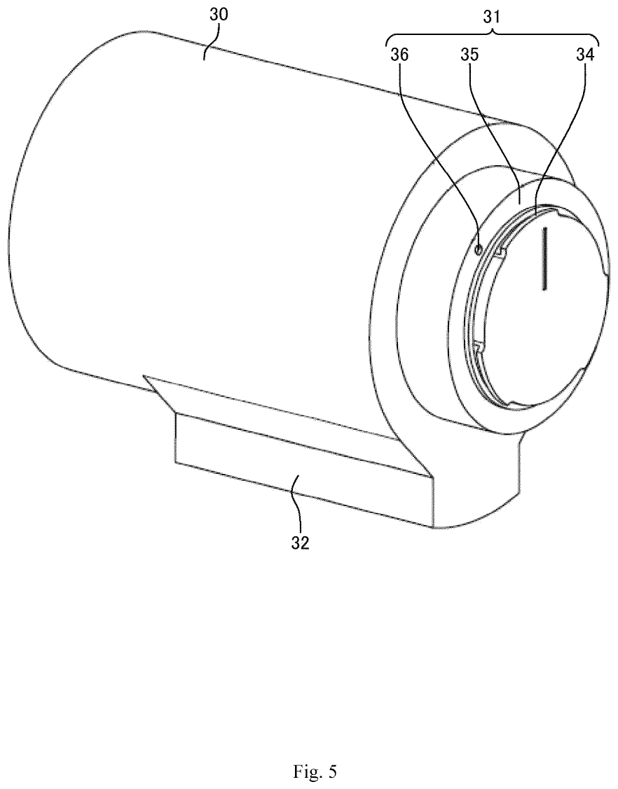

However, in one embodiment, in the interchangeable lens, for example, as in the interchangeable lens 30 shown in FIG. 5, there are interchangeable lenses that include a protruding portion 32 that protrudes from an outer periphery of the interchangeable lens 30. The protruding portion 32 is a part of the outer periphery of the interchangeable lens 30. The protruding portion 32 has at least a portion of, for example, a motorized zoom mechanism built in. The motorized zoom mechanism is a drive mechanism that moves at least one lens of the zoom lens set in the optical axis direction. The motorized zoom mechanism may be a mechanism for making the focal length of the interchangeable lens infinitely variable between the wide-angle side and the telephoto side by moving the at least one lens of the zoom lens group in the optical axis direction. The motorized zoom mechanism may include gears and a motor as the driving mechanism.

In one embodiment, the interchangeable lens 30 includes, at the back, a mount structure 31 coupled to the mount module 300. The mount structure 31 includes an engagement portion 34 that protrudes from an outer peripheral surface and snaps into place with an engagement portion 305 of the mount module 300. The mount structure 31 includes a mount face 35 that is opposite the mount face 302 of the mount module 300. The mount structure 31 includes a hole 36 in the mount face 35 into which a pin 304 protruding from the mount face 302 of the mount module 300 is embedded. The mount structure 31 includes a plurality of electrical contacts on the mount face, the plurality of electrical contacts being electrically connected to the plurality of electrical contacts of the mount module 300.

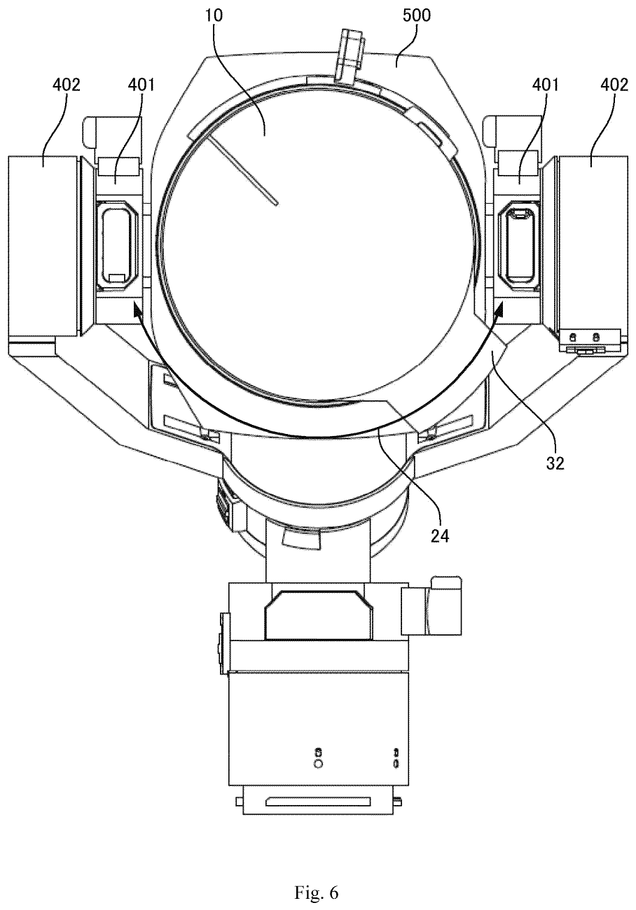

In one embodiment, when the interchangeable lens 30 includes the protruding portion 32, as shown in FIG. 6, sometimes the protruding portion 32 of the interchangeable lens 30 and the pair of first retaining members 401 are located on the same arc 24 around the optical axis of the photographing device 500. In this case, similarly to the interchangeable lens 10 shown in FIG. 4, when the interchangeable lens 30 is rotated 70 degrees and is to be mounted to the mount module 300, the protruding portion 32 may interfere with the first retaining member 401 and the protruding portion 32 may collide with the first retaining member 401.

In one embodiment, in lens specifications, for example, for an interchangeable lens 30 that can be mounted by rotating 70 degrees with respect to the mount, in order to avoid collision of the protruding portion 32 with the first retaining member 401, a mount module 300 is designed such that if the interchangeable lens 30 is rotated by, for example, 45 degrees, the engagement portion 34 of the interchangeable lens 30 and the engagement portion 305 of the mount module 300 will be engaged, so that the interchangeable lens 30 is mounted to the mount module 300.

However, even in the case where the mount module 300 is designed in this manner, the protruding portion 32 may collide with the first retaining member 401 when the button 306 is pressed to remove the interchangeable lens 30 in the case of the interchangeable lens capable of being further rotated in the same direction of rotation 22, the direction in which the interchangeable lens 30 is mounted.

Thus, in one embodiment, when the interchangeable lens 30 capable of being mounted in different mounts at different amounts of rotation (e.g., 45 degrees and 70 degrees) is removed from the mountable mount module 300 at a lesser amount of rotation (e.g., 45 degrees), the interchangeable lenses 30 cannot be further rotated in the opposite direction with respect to the direction of the removal of the mount module 300.

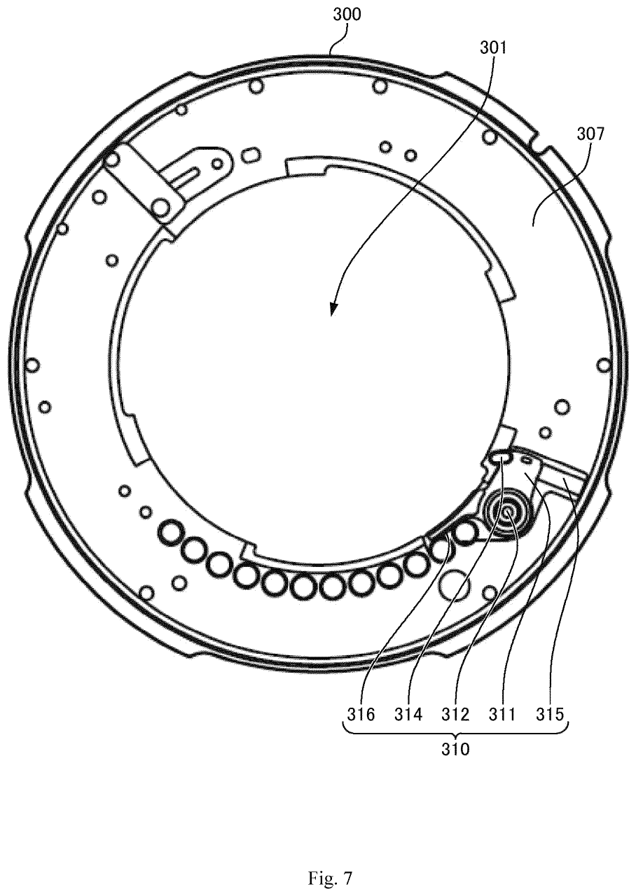

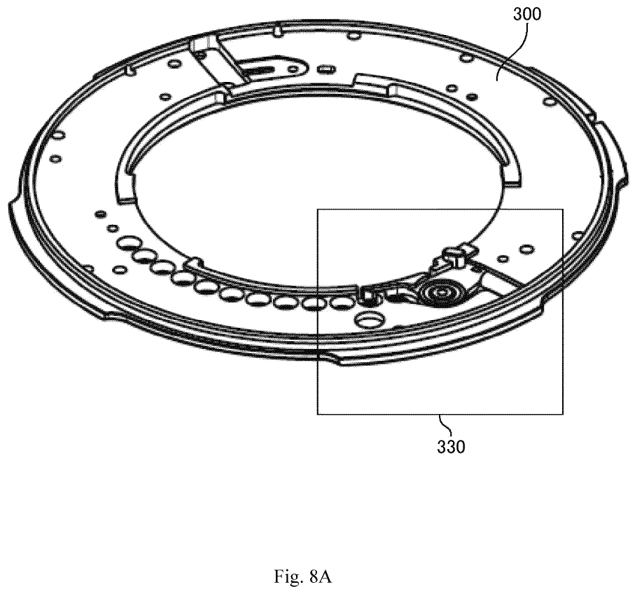

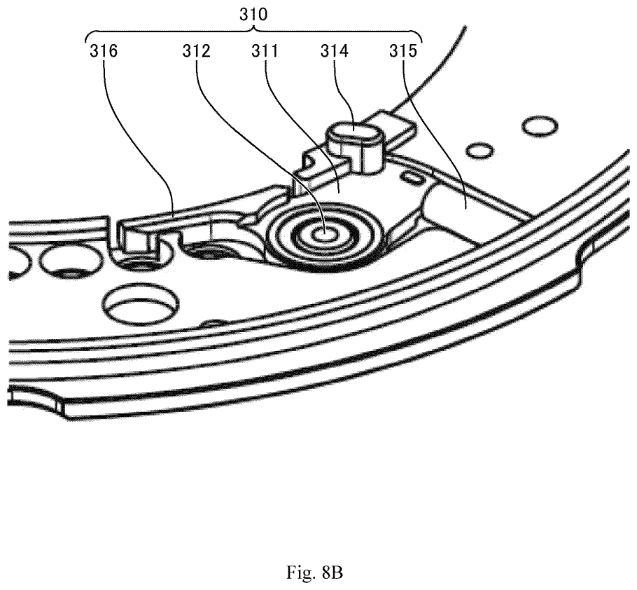

FIG. 7 is a top view from a back side 307 of the mount module 300 on an opposite side from the mount face 302 according to one embodiment of the present disclosure. FIG. 8A is a three-dimensional view observed from the back side 307 of the mount module 300 according to one embodiment of the present disclosure. FIG. 8B is a partially enlarged view of a portion of the mount module 300 at the frame 330 shown in FIG. 8A according to one embodiment of the present disclosure.

In one embodiment, the mount module 300 includes a restriction mechanism or structure 310 that restricts the rotation of the interchangeable lens 30. The restriction mechanism 310 includes a rotating member or structure 311 that is rotatably disposed on the backside 307 around a shaft portion 312 that is oriented in the direction of the optical axis. The rotating member 311 includes a pressing portion 314 at one end, and an arm portion 316 at the other end. The restriction mechanism 310 also includes a resilient member 315. The resilient member 315 may be a spring. The resilient member 315 exerts a force that presses the pressing portion 314 in the direction of the inner side of the opening 301 (the center side of the opening 301).

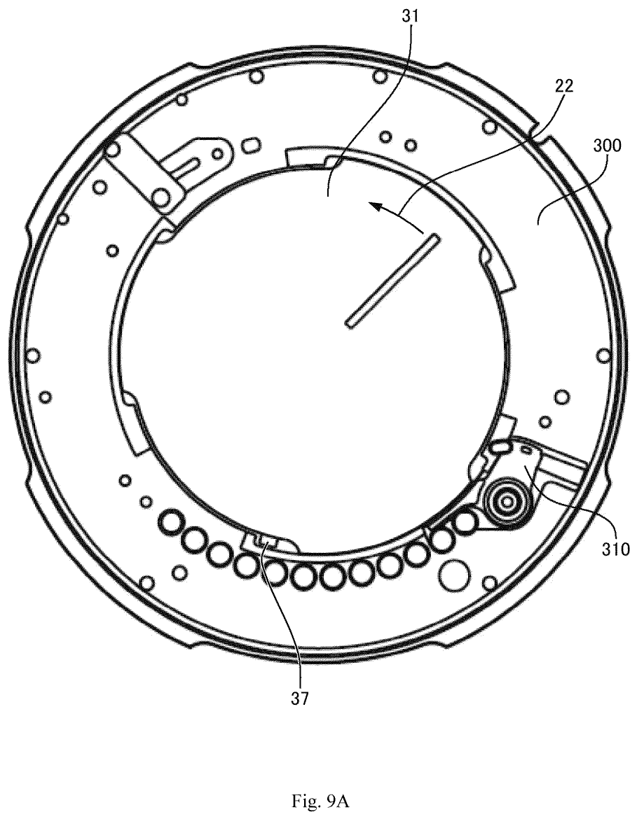

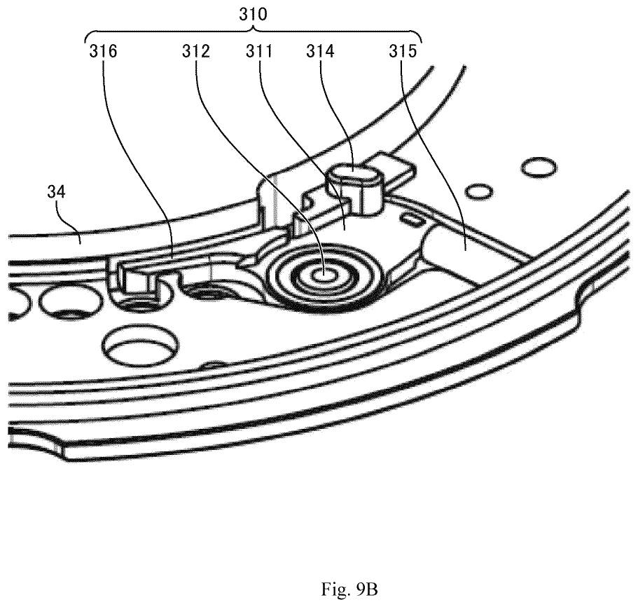

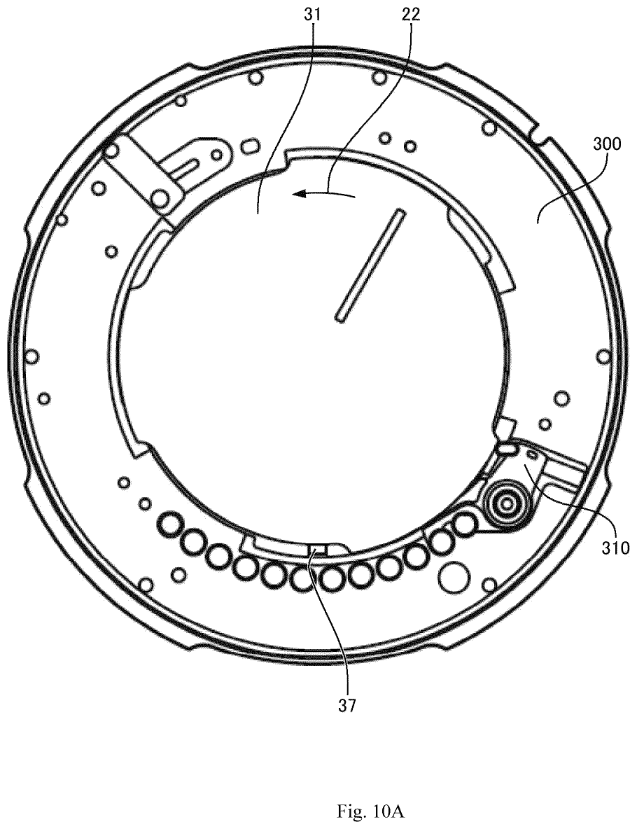

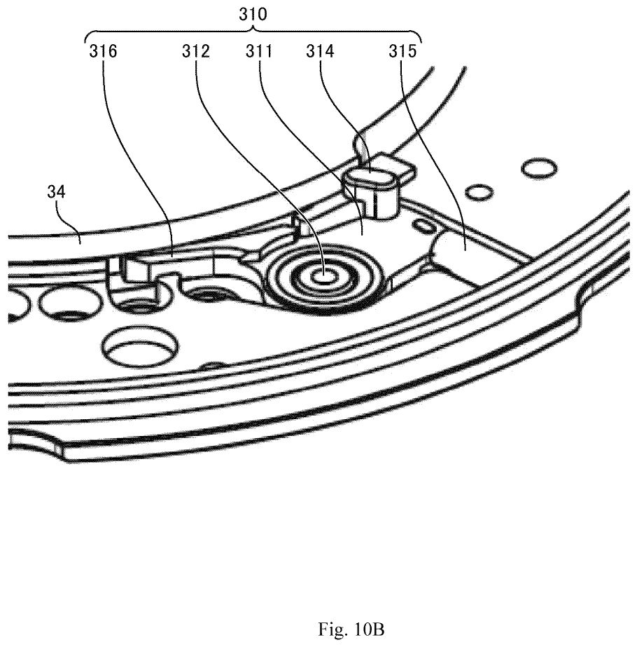

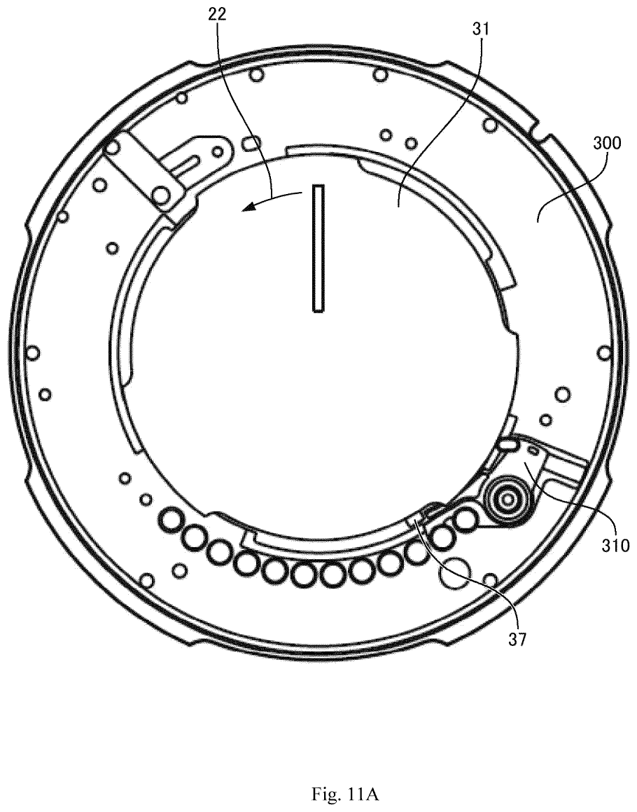

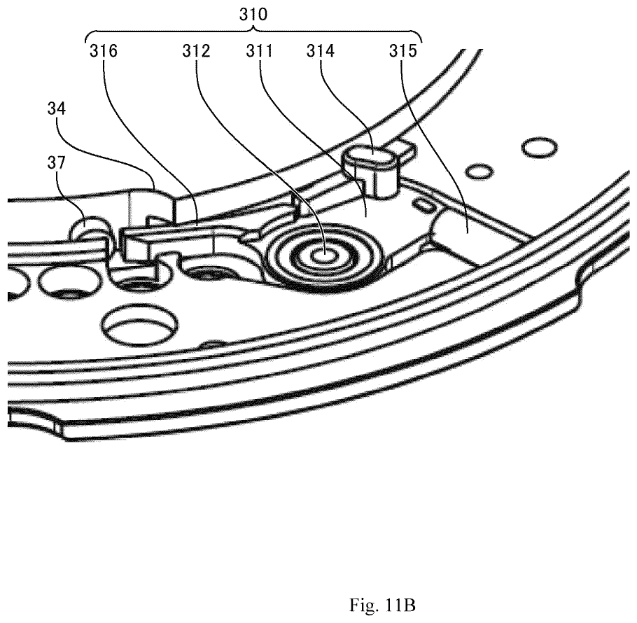

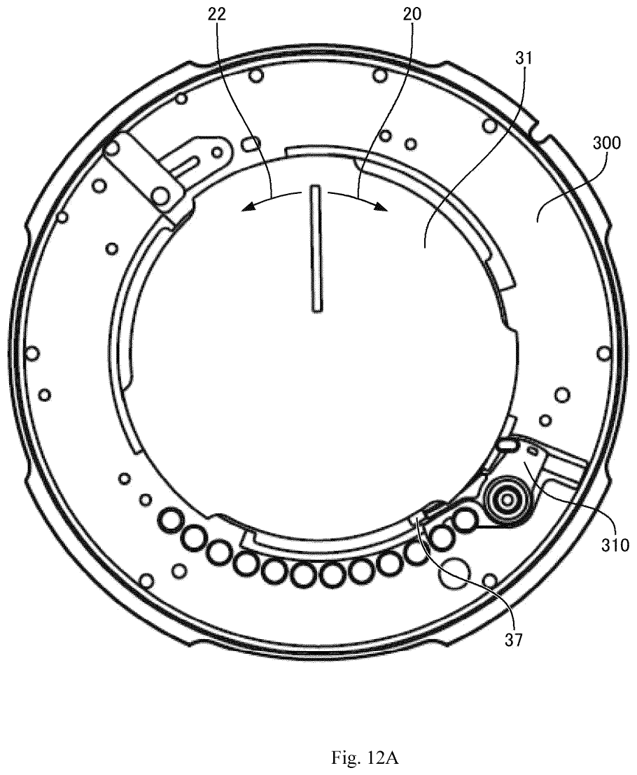

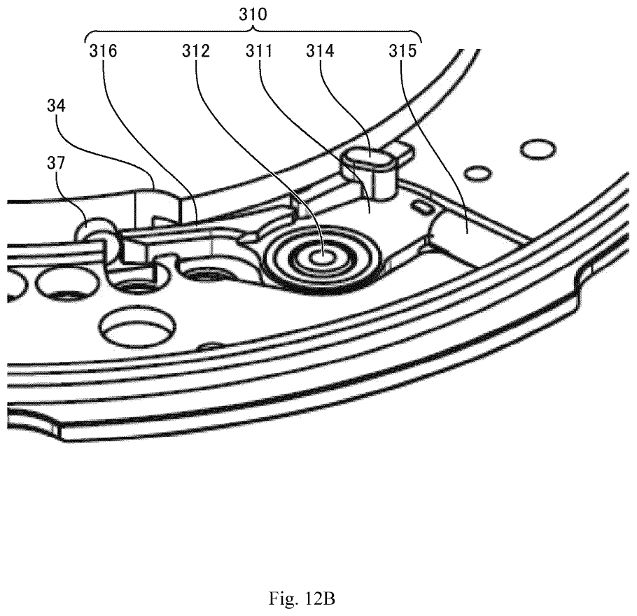

FIGS. 9A and 9B to FIGS. 12A and 12B illustrate the interchangeable lens 30 mounted to the mount module 300 according to some embodiments of the present disclosure. FIG. 9B, FIG. 10B, FIG. 11B, and FIG. 12B illustrate partial enlargements of the mount module 300 shown in FIG. 9A, FIG. 10A, FIG. 11A, and FIG. 12A, respectively.

FIGS. 9A and 9B illustrate a state in which the mount structure 31 of the interchangeable lens 30 falls into the opening 301 of the mount module 300 according to one embodiment of the present disclosure. In this state, the pressing portion 314 of the rotating member 311 is pressed into the inner side of the opening 301 by the resilient member 315. As a result, the rotating member 311 is rotated around the shaft portion 312, and the arm portion 316 is disposed on the outer side of the opening 301.

FIGS. 10A and 10B illustrate a state in which the interchangeable lens 30 has been rotated 10 degrees relative to the mount module 300 in the rotational direction 22 from a state in which the mount structure 31 of the interchangeable lens 30 falls into the opening 301 of the mount module 300 according to one embodiment of the present disclosure. In this state, the pressing portion 314 is in contact with the outer peripheral surface of the engagement portion 34 of the interchangeable lens, and the pressing portion 314 is pressed into the outer side of the opening 301. As a result, the rotating member 311 is rotated around the shaft portion 312, and the arm portion 316 is moved toward the inner side of the opening 301.

FIGS. 11A and 11B illustrate a state in which the interchangeable lens 30 is rotated to a second rotational position (e.g., 45 degrees) relative to the mount module 300 according to one embodiment of the present disclosure. That is, the pin 304 of the mount module 300 is embedded in the hole 36 of the mount structure 31 of the interchangeable lens 30, completing the state in which the interchangeable lens 30 is mounted to the mount module 300. The interchangeable lens 30 includes a protruding structure 37 in the vicinity of the engagement portion 34 of the mount structure 31, which protrudes from an outer peripheral surface. In the state in which the arm portion 316 is moved toward the inner side of the opening 301, the protruding structure 37 and the arm portion 316 are disposed on the same arc of a circle centered on the optical axis. However, in the state where the installation of the interchangeable lens 30 into the mount module 300 is completed, the arm portion 316 is located on the outer side of the opening 301, but has not yet contacted the protruding structure 37.

FIGS. 12A and 12B illustrate a state in which the interchangeable lens 30 is rotated further along the direction of rotation 22 relative to the mount module 300 from the second rotational position according to one embodiment of the present disclosure. In order to remove the interchangeable lens 30 from the mount module 300 from the state of completing the mounting of the interchangeable lens 30 to the mount module 300, it is necessary to rotate the interchangeable lens 30 relative to the mount module 300 in the rotational direction 20 opposite to the rotational direction 22. However, in the state of pressing the button 306, the user sometimes mistakenly rotates the interchangeable lens 30 further in the rotational direction 22 with respect to the mount module 300. Even in that case, since the protruding structure 37 and the arm portion 316 are disposed on the same arc of a circle centered on the optical axis, the arm portion 316 is in contact with the protruding structure 37, restricting the interchangeable lens 30 from rotating further in the rotational direction 22 with respect to the mount module 300 from the second rotational position.

According to the restriction mechanism 310 involved in this embodiment, the arm portion 316 switches from a first state to a second state protruding more toward the inner side of the opening 301 than the first state during rotation of the interchangeable lens 30 from the first rotational position to the second rotational position. When the arm portion 316 is in the second state, the arm portion 316 restricts the interchangeable lens 30 from rotating further in the second rotational direction from the second rotational position to the third rotational position through contacting the protruding structure 37 protruding from the outer periphery of the mount structure 31 of the interchangeable lens 30.

During rotation of the interchangeable lens 30 from the fourth rotational position between the first rotational position and the second rotational position to the second rotational position, the pressing portion 314 presses toward the engagement portion 34 of the interchangeable lens 30, and the rotating member 311 rotates around the shaft portion 312 so as to move outwardly from the opening 301. The fourth rotational position is, for example, a position at which the interchangeable lens 30 is rotated 10 degrees relative to the mount module 300 from the first rotational position at which the mount structure 31 of the interchangeable lens falls into the opening 301 of the mount module 300.

Accompanied by the pressing portion 314 toward the engagement portion 34, the rotating member 311 is rotated around the shaft portion 312, and the arm portion 316 protrudes toward the inner side of the opening 301. The arm portion 316 restricts the interchangeable lens 30 from rotating further in the rotational direction 22 from the second rotational position to the third rotational position by contacting the protruding structure 37 of the interchangeable lens 30. During rotation of the interchangeable lens 30 from the fourth rotational position to the second rotational position, at least a portion of the arm portion 316 overlaps in the optical axis direction with respect to the engagement portion 34. That is, the arm portion 316 is not present on the track of the engagement portion 34 even in the state of protruding inwardly toward the opening 301, and there is no chance that the arm portion 316 will come into contact with the engagement portion 34 and impede the rotation of the interchangeable lens 30.

Because the arm portion 316 protrudes toward the inner side of the opening 301, the interchangeable lens 30 cannot be excessively rotated in a direction opposite to the direction in which it is removable with respect to the mount module 300. Thus, the protruding portion 32 of the interchangeable lens 30 can be prevented colliding with the first retaining member 401 of the gimbal 400.

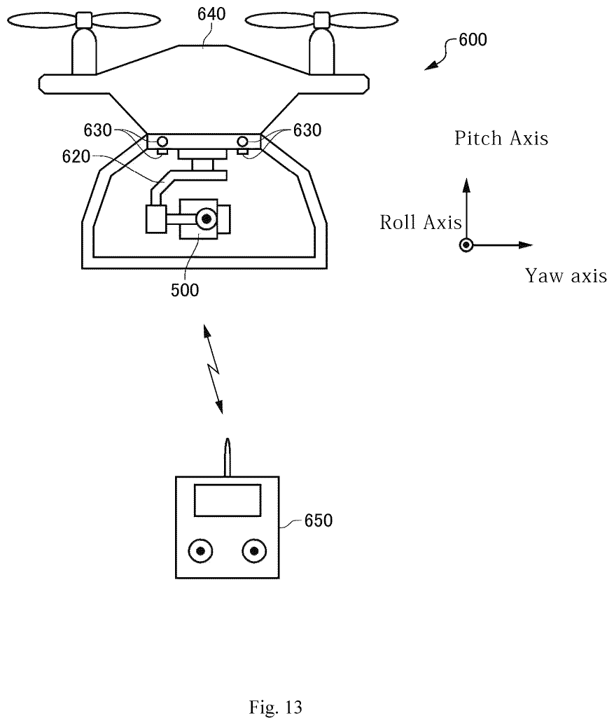

The photographing device 500 described above may be mounted on a mobile body. The photographing device 500 may be mounted on an unmanned aerial vehicle (UAV) as shown in FIG. 13. The UAV 600 may include a UAV body 640, a gimbal 620, a plurality of camera devices 630, and a photographing device 500. The gimbal 620 and the photographing device 500 are an example of a camera system. The UAV 600 is an example of a mobile body propelled by a propulsion section. The concept of a mobile body refers to a flying body including an airplane and the like moving in the air, a vehicle moving on the ground, a ship moving on water, and the like, in addition to the UAV.

The UAV body 640 may include a plurality of rotors. The plurality of rotors is an example of a propulsion section. The UAV body 640 may cause the UAV 600 to fly by controlling the rotation of the plurality of rotors. The UAV body 640 may employ, for example, four rotors to cause the UAV 600 to fly. The number of rotors is not limited to four. Alternatively, the UAV 600 may be a fixed wing aircraft without rotors.

The photographing device 500 may be a camera for taking pictures of a subject included in a desired camera range. The gimbal 620 may rotatably support the photographing device 500. The gimbal 620 is an example of a support mechanism. For example, the gimbal 620 may use an actuator to rotatably support the photographing device 500 around a pitch axis. The gimbal 620 may use an actuator to further rotatably support the photographing device 500 around a roll axis and a yaw axis, respectively. The gimbal 620 may change the posture of the photographing device 500 by causing the photographing device 500 to rotate around at least one of the yaw axis, the pitch axis, and the roll axis.

The plurality of camera devices 630 may be cameras for sensing the surrounding of the UAV 600 in order to control the flight of the UAV 600. Two of the camera devices 630 may be provided at the nose, i.e., the front side, of the UAV 600. Moreover, the other two camera devices 630 may be provided on the bottom side of the UAV 600. The two camera devices 630 on the front side may be in pairs to function as a so-called stereoscopic camera. The two camera devices 630 on the bottom side may also be paired to function as a stereo camera. Three-dimensional spatial data around the UAV 600 can be generated based on images captured by the plurality of camera devices 630, and the number of camera devices 630 included in the UAV 600 is not limited to four; it is sufficient for the UAV 600 to include at least one photographing device 630, and the UAV 600 can also include at least one photographing device 630 in the nose, tail, side, bottom, and top surfaces of the UAV 600, respectively. The photographing device 630 may have a programmable viewing angle that is greater than the programmable viewing angle of the photographing device 500. The photographing device 630 may also include a monofocal lens or a fisheye lens.

The remote operating device 650 may communicate with the UAV 600 to remotely operate the UAV 600. The remote operation device 650 may communicate with the UAV 600 wirelessly. The remote operation device 650 may send to the UAV 600 indication information indicating various instructions relating to movement of the UAV 600 such as rising, falling, accelerating, decelerating, advancing, receding, rotating, and the like. The indication information includes, for example, indication information that causes the height of the UAV 600 to rise. The indication information may indicate an altitude at which the UAV 600 should be located. The UAV 600 may perform a movement to be located at the altitude indicated by the indication information received from the remote operation device 650. The indicative information may include a rise command that causes the UAV 600 to rise. The UAV 600 rises during the period in which the rise command is received. When the height of the UAV 600 has reached an upper limit height, the UAV 600 may be restricted from rising even if the rising instruction is accepted.

The disclosure is illustrated above using the embodiments, but the technical scope of the disclosure is not limited to the scope described in the above embodiments. It is apparent to a person of ordinary skill in the art that various changes or improvements can be made to the above embodiments. It is obvious from the description of the claims that the manner in which such modifications or improvements are made may be included in the technical scope of the present disclosure.

It should be noted that the order of execution of actions, processes, steps, stages, and other treatments in the apparatus, system, program, and method shown in the claims, the specification, and the drawings accompanying the specification may be realized in any order as long as the words “before”, “in advance”, etc. are not specifically indicated. “, etc., and as long as the output of the preceding process is not used in the following process, the order of execution can be arbitrary. The flow of operations in the claims, the specification, and the drawings accompanying the specification are described for convenience by using the words “first,” “next,” etc., but this does not mean that they must be implemented in such an order.

The above mentioned is only a specific implementation of the present application, but the scope of protection of the present application is not limited to this, and any person skilled in the art can easily think of various equivalent modifications or substitutions within the technical scope disclosed in the present application, which should be covered by the scope of protection of the present application. Therefore, the scope of protection of this application shall be subject to the scope of protection of the claims.

What is claimed is:

1. A mount of a photographing device, comprising:
a mount module to mount an interchangeable lens, the mount module comprising an opening to embed a portion of a mount structure of the interchangeable lens, a first engagement portion protruding inwardly into the opening, and a first mount face opposite to a second mount face of the interchangeable lens, and
a restriction structure,
wherein when the interchangeable lens rotates from a first rotational position to a second rotational position in a first rotational direction, the first engagement portion engages with a second engagement portion protruding from an outer peripheral surface of the mount structure of the interchangeable lens,
when the interchangeable lens rotates from the second rotational position to the first rotational position in a second rotational direction opposite to the first rotational direction, the first engagement portion is disengaged from the second engagement portion, and
the restriction structure restricts further rotation of the interchangeable lens from the second rotational position in the first rotational direction to a third rotational position.

2. The mount according to claim 1, wherein the restriction structure comprises an arm portion, the arm portion switching from a first state to a second state during rotation of the interchangeable lens from the first rotational position to the second rotational position, the arm portion protruding more inwardly toward the opening in the second state than in the first state, and
when the arm portion is in the second state, the arm portion restricts the further rotation of the interchangeable lens from the second rotational position in the first rotational direction to the third rotational position by contacting a protruding structure protruding from the outer periphery surface of the mount structure of the interchangeable lens.

3. The mount according to claim 1, wherein the restriction structure comprises a rotating structure rotatably disposed on a backside of the mount module around a shaft portion that is oriented in an optical axis direction of the photographing device, the backside of the mound assembly being opposite to a side of the first mount face;
the rotating structure includes a pressing portion and an arm portion at both ends of the rotating structure respectively,
during rotation of the interchangeable lens from a fourth rotational position between the first rotational position and the second rotational position to the second rotational position, the pressing portion is pressed toward the second engagement portion, and the rotating structure rotates around the shaft portion so that the pressing portion moves outwardly from the opening and the arm portion protrudes inwardly toward the opening, and
when the interchangeable lens is at the second rotational position, the arm portion restricts the further rotation of the interchangeable lens from the second rotating position in the first rotational direction to the third rotational position by contacting with a protruding structure protruding from the outer peripheral surface of the mount structure of the interchangeable lens.

4. The mount according to claim 3, wherein the restriction structure further comprises a resilient structure, the resilient structure exerting a force that presses the pressing portion in a direction toward the inner side of the opening.

5. The mount according to claim 4, wherein the resilient structure is a spring.

6. The mount according to claim 3, wherein during the rotation of the interchangeable lens between the fourth rotational position and the second rotational position, at least a portion of the arm portion overlaps the second engagement portion in the optical axis direction.

7. The mount according to claim 1, wherein the mount module further comprises a pin, the pin protruding from the first mount face and embedded in a hole in the second mount face when the interchangeable lens reaches the second rotational position.

8. The mount according to claim 7, wherein the mount module further comprises a button mechanically coupled to the pin at an outer periphery of the first mount face to press the pin into an interior of the first mount face.

9. The mount according to claim 1, wherein the mount module further comprises a plurality of electrical contacts on the first mount face, which are electrically connected to a plurality of electrical contacts provided on the second mount face of the interchangeable lens when the interchangeable lens reaches the second rotational position.

10. The mount according to claim 1, wherein the first mount surface is annular in shape.

11. The mount according to claim 1, wherein the mount module is detachably secured to the photographing device via an intermediate mount.

12. The mount according to claim 11, wherein the photographing device comprises a housing, wherein the intermediate mount, the mount module, and the interchangeable lens are detachably disposed on the housing.

13. A camera system, comprising:
the photographing device comprising the mount according to claim 1; and
a support structure rotatably supporting the photographing device.

14. The camera system according to claim 13, wherein the support structure comprises:
a pair of first retaining structures which retain the photographing device;
a pair of first rotating structures which rotate the photographing device around a first axis by means of the pair of first retaining structures;
a second retaining structure which holds the pair of first rotating structures;
a second rotating structure which rotates the photographing device by means of the second retaining structure around a second axis;
a third retaining structure which holds the second rotating structure; and
a third rotating structure which rotates the photographing device by means of the third retaining structure around a third axis.

15. The camera system according to claim 13, further comprising the interchangeable lens detachably coupled to the mount;
in a state in which the interchangeable lens is mounted to the mount, the interchangeable lens is disposed between the pair of first retaining structures, and a portion of the outer periphery of the interchangeable lens and the pair of first retaining structures are disposed on a same arc of a circle centered around an optical axis of the photographing device.

16. The camera system according to claim 15, wherein
the interchangeable lens includes a motorized zoom structure; and
the portion of the outer peripheral of the interchangeable lens includes at least a portion of the motorized zoom structure.

17. The camera system according to claim 14, wherein the first axis is a pitch axis, the second axis is a roll axis, and the third axis is a yaw axis.

18. A mobile body, comprising the camera system of 10.

19. The mobile body according to claim 18, wherein the mobile body is an unmanned aerial vehicle.
